(19) United States
(12) Patent Application Publication
(10) Pub. No.: US 2021/0246262 A1
(43) Pub. Date: Aug. 12, 2021

(54) POLYESTER FILM FOR BEING EMBOSSED WITH LASER-ENGRAVED PATTERN AND MANUFACTURING METHOD THEREOF

(71) Applicant: NAN YA PLASTICS CORPORATION, Taipei (TW)

(72) Inventors: Te-Chao Liao, Taipei (TW); Wen-Cheng Yang, Taipei (TW); Wen-Jui Cheng, Taipei (TW); Chia-Yen Hsiao, Taipei (TW)

(21) Appl. No.: 17/137,364

(22) Filed: Dec. 30, 2020

(30) Foreign Application Priority Data
Feb. 7, 2020 (TW) 109103793

(51) Int. Cl. C08G 63/183; B32B 27/36; B32B 27/08; B32B 37/15

(52) U.S. Cl. CPC C08G 63/183; B32B 27/36; B32B 2307/306; B32B 37/153; B32B 2367/00; B32B 27/08

(57) ABSTRACT

A polyester film for being embossed with a laser-engraved pattern and a manufacturing method thereof are provided. The polyester film includes a substrate layer and at least one surface layer formed on the substrate layer. The surface layer serves as an easy-to-press embossed pattern layer, and is formed from a polyester-based copolymer. The polyester-based copolymer includes residues derived from a diacid component and residues derived from a diol component. The diacid component includes 85 to 95 mol % of terephthalic acid and 5 to 15 mol % of isophthalic acid. The diol component includes 35 to 74 mol % of ethylene glycol, 1 to 15 mol % of neopentyl glycol, and 25 to 50 mol % of 1,4-butanediol.

### CROSS-REFERENCE TO RELATED PATENT APPLICATION

This application claims the benefit of priority to Taiwan Patent Application No. 109103793, filed on Feb. 7, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester film, and more particularly to a polyester film for being embossed with a laser-engraved pattern and a manufacturing method thereof.

### BACKGROUND OF THE DISCLOSURE

With the improvement of modern day living standards, electronic products such as mobile phones, tablets, notebooks, household appliances, and automotive products have begun to become popular, and people tend to pursue more in diversification of appearance and overall quality of the products. In addition, interior decorative materials based on personal preferences of furniture, doors, walls, door handles, etc., are becoming increasingly abundant. These products usually have a personalized 2D/3D pattern or special color effects on their exterior surfaces. For example, high end car interiors and furniture are provided with special effects on their appearances such as imitation of wood grain, a soft velvety feel, and metallic color effects.

Polyesters (e.g., polyethylene terephthalate and polyethylene 2,6-naphthalene dicarboxylate) provides good performances on formability, mechanical properties, thermal properties, electrical properties, and chemical resistance, and thus they are suitable for various applications. Polyester films serving as decorative films can be provided with a variety of textures or patterns by an embossing process or a printing process so as to attract consumers. In the embossing process, a stamper (also referred to as a template) with a three-dimensional texture or pattern is used to press against a surface of a target object. Accordingly, the three-dimensional texture or pattern can be precisely transferred to the surface of the target object. Compared to a planar pattern, an embossed pattern can appear better with a three-dimensional effect.

The conventional manufacturing method of a decorative polyester film includes: applying a polyester surface coating material onto a polyester substrate; dry curing the polyester surface coating material; and forming a desired texture or pattern on the resulting surface coating by a stamper. However, the conventional manufacturing method not only requires complicated processing steps which may result in a low yield, but is also difficult to form a clear and apparent texture or pattern by pressing.

### SUMMARY OF THE DISCLOSURE

In response to the above-referenced technical inadequacies, the present disclosure provides a polyester film for being embossed with a laser-engraved pattern and a manufacturing method thereof.

In one aspect, the present disclosure provides a polyester film for being embossed with a laser-engraved pattern, which includes a substrate layer and at least one surface layer. The at least one surface layer is formed on the substrate layer, in which a material of the at least one surface layer is a polyester-based copolymer. The polyester-based copolymer includes residues derived from a diacid component and residues derived from a diol component. The diacid component includes 85 to 95 mol % of terephthalic acid and 5 to 15 mol % of isophthalic acid. The diol component includes 35 to 74 mol % of ethylene glycol, 1 to 15 mol % of neopentyl glycol, and 25 to 50 mol % of 1,4-butanediol.

In another aspect, the present disclosure provides a manufacturing method of a polyester film for being embossed with a laser-engraved pattern, which includes the steps of forming a substrate layer and at least one surface layer on the substrate layer in a multi-layered co-extrusion manner and stretching the substrate layer and the at least one surface layer in the machine direction (MD) and the transverse direction (TD). A material of the at least one surface layer is a polyester-based copolymer. The polyester-based copolymer includes residues derived from a diacid component and residues derived from a diol component. The diacid component includes 85 to 95 mol % of terephthalic acid and 5 to 15 mol % of isophthalic acid. The diol component includes 35 to 74 mol % of ethylene glycol, 1 to 15 mol % of neopentyl glycol, and 25 to 50 mol % of 1,4-butanediol.

In certain embodiments, a material of the substrate layer is polyethylene terephthalate.

In certain embodiments, the at least one surface layer contains 0.0003 to 2 wt % of a nucleating agent.

In certain embodiments, the substrate layer contains 0.0003 to 2 wt % of a nucleating agent.

In certain embodiments, a thickness of the at least one surface layer is 1% to 30% of a total thickness of the polyester film A thickness of the substrate is between 11 μm and 100 μm.

In certain embodiments, the thickness of the at least one surface layer is 2% to 20% of the total thickness of the polyester film.

In certain embodiments, the thickness of the at least one surface layer is 3% to 15% of the total thickness of the polyester film.

In certain embodiments, a melting point of the polyester-based copolymer is 190° C. to 240° C.

In certain embodiments, a melting point of the polyester-based copolymer is 195° C. to 230° C.

One of the effects of the present disclosure is that the polyester film can be embossed with a clear laser-engraved pattern on a surface thereof which has different shades of color, by virtue of “the at least one surface layer is formed on the substrate layer and a material thereof is a polyester-based copolymer that includes residues derived from a diacid component and residues derived from a diol component” and “the diacid component includes 85 to 95 mol % of terephthalic acid and 5 to 15 mol % of isophthalic acid, and the diol component includes 35 to 74 mol % of ethylene glycol, 1 to 15 mol % of neopentyl glycol and 25 to 50 mol % of 1,4-butanediol.”

The manufacturing method of the polyester film, which uses a multi-layered co-extrusion manner to form two, three, or more functional polyester layers that are laminated together, can efficiently reduce the processing difficulty and improve the yield of finished products.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a polyester film for being embossed with a laser-engraved pattern according to an embodiment of the present disclosure.

FIG. 2 is a schematic view of the polyester film for being embossed with the laser-engraved pattern according to the embodiment of the present disclosure in a use state.

FIG. 3 is a schematic view of a polyester film for being embossed with a laser-engraved pattern according to another embodiment of the present disclosure. FIG. 4 is a schematic view of a polyester film for being embossed with a laser-engraved pattern according to still another embodiment of the present disclosure.

FIG. 5 is a flowchart of a manufacturing method of a polyester film for being embossed with a laser-engraved pattern according to embodiments of the present disclosure.

### DETAILED DESCRIPTION OF THE EXEMPLARY EMBODIMENTS

Polyester films have a wide range of uses, including at least processed paper products, flat prints, packages and labels of articles or foods, and decorative skins. In addition, an embossed pattern can allow a polyester film product to have an aesthetic and unique appearance along with an added value. In particular, there are many types of laser-engraved embossed patterns, and the resulting effects cannot be obtained by general printed patterns. Therefore, the present disclosure provides a technical solution that can easily form an uneven three-dimensional embossed pattern on a surface of a polyester film.

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

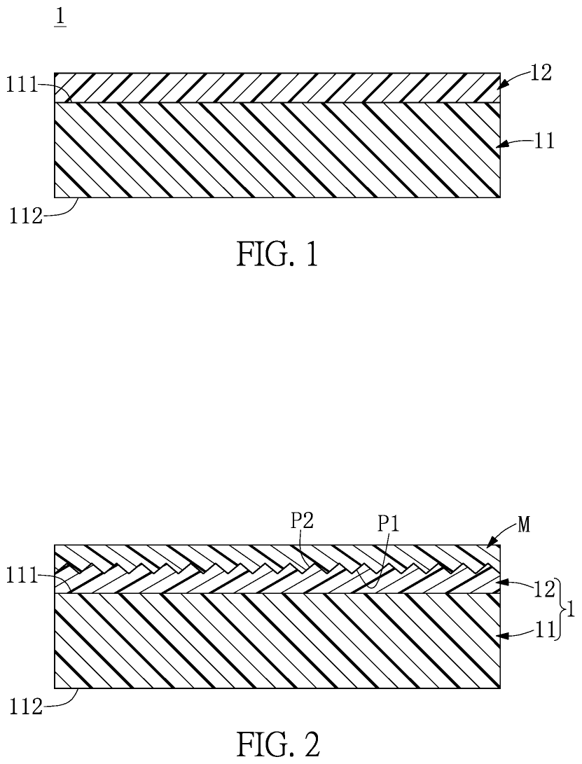

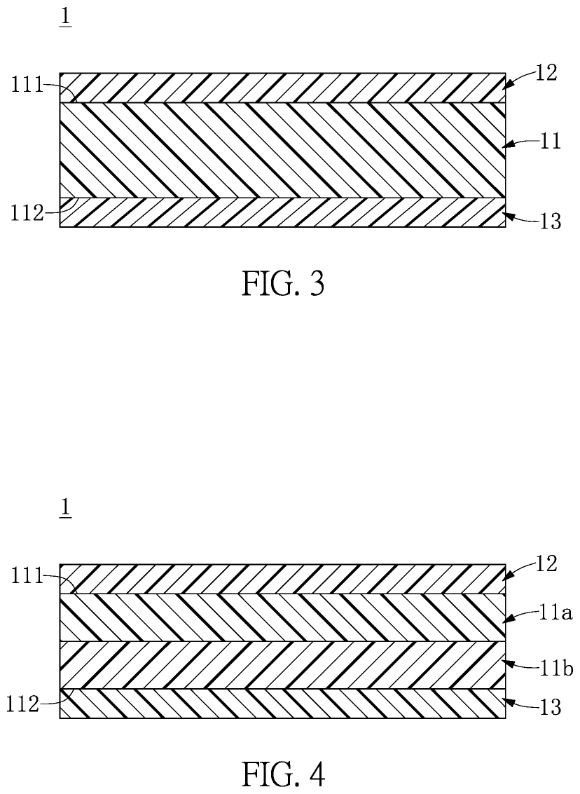

Referring to FIG. 1, a first embodiment of the present disclosure provides a polyester film 1 for being embossed with a laser-engraved pattern, which is a double-layered structure including a substrate layer 11 and a first surface layer 12. The substrate layer 11 has a first surface 111 and a second surface 112 opposite to the first surface 111. The first surface 111 is, for example, an upper surface of the substrate layer 11, and the second surface 112 is, for example, a lower surface of the substrate layer 11. The first surface layer 12 is formed on the first surface 111 of the substrate layer 11, and is an easy-to-press embossed pattern layer.

In practice, a three-dimensional embossed pattern P1 can be formed on a metal stamper M by laser engraving, and subsequently, the metal stamper M can be used to press against the first surface layer 12 of the polyester film 1. If necessary, the metal stamper M can be heated to a predetermined temperature (such as 200° C.), so that the first surface layer 12 has another three-dimensional embossed pattern P2 that is inverse to the three-dimensional embossed pattern P1 in unevenness. However, these details are provided for exemplary purposes only and are not meant to limit the scope of the present disclosure.

In the present embodiment, the material of the first surface layer 12 is a polyester-based copolymer that includes residues derived from a diacid component and residues derived from a diol component. The diacid component includes 90 mol % of terephthalic acid and 10 mol % of isophthalic acid. The diol component includes 49 mol % of ethylene glycol, 1 mol % of neopentyl glycol, and 50 mol % of 1,4-butanediol. The total thickness of the polyester film 1 is 12 μm, in which the thickness of the first surface layer 12 is 1 μm. The polyester-based copolymer has a glass transition temperature (Tg) of 45° C. and a melting point (Tm) of 223° C. The polyester film 1 has an excellent processability (e.g., calenderability), such that it can be easily embossed.

It should be noted that the above-mentioned components can increase the crystallinity of the polyester-based copolymer, thereby increasing the heat resistance of the first surface layer 12. In addition, the above-mentioned components can also decrease the melting point of the polyester-based copolymer, and thus the embossing processability of the first surface layer 12 can be increased.

The term “residue” as used herein refers to a group or unit derived from a specific compound in a product resulted from a chemical reaction. That is, the residue of the diacid component is a group derived from the diacid component in a polyester or copolyester synthesized by an esterification or polycondensation reaction. The residue of the diol component is a group derived from the diol component in a polyester or copolyester synthesized by an esterification or polycondensation reaction.

More specifically, the melting point of the polyester-based copolymer of the first surface layer 12 is between 190° C. and 240° C., and preferably between 195° C. and 230° C. If the melting point of the polyester-based copolymer is higher than 240° C., the embossing processability would be negatively affected. If the melting point of the polyester-based copolymer is lower than 190° C., the film forming processability would be negatively affected. The melting point of a part of the composition cannot be measured under general DSC thermal analysis conditions, and it needs to be analyzed using special instruments or pretreatment methods. Furthermore, the thickness of the first surface layer 12 is 1% to 30% of the total thickness of the polyester film 1, preferably 2% to 20%, and more preferably 3% to 15%. If the thickness of the first surface layer 12 is greater than 30% of the total thickness, the film forming processability would be negatively affected. If the thickness of the first surface layer 12 is less than 1% of the total thickness, the effect of the resulting embossed pattern may be unsatisfactory. It is worth mentioning that, the first surface layer 12 has an excellent processability (e.g., calenderability), such that it can be easily embossed.

In order to further increase the heat resistance and processability of the first surface layer 12, the first surface layer 12 can contain 0.0003 to 2 wt % of a nucleating agent. The nucleating agent may be a mineral material, a metal oxide, a silicon compound, a metal salt of an organic or inorganic acid, a metal salt of an aromatic phosphate ester, a polyol derivative, a sulfonylimide compound, a glass powder, a metal powder, or any combination thereof. The nucleating agent can increase total crystallinity, such that the heat resistance of the first surface layer 12 can be improved. Furthermore, the nucleating agent can promote crystal growth, which results in a finer crystal size, a reduced amount of large spherulites, and can avoid embrittlement of a film surface.

Specific examples of the mineral material include graphite, talc, and kaolin. Specific examples of the metal oxide include zinc oxide, aluminum oxide, and magnesium oxide. Specific examples of the silicon compound include silicon oxide, calcium silicate, and magnesium silicate. Specific examples of the metal salt of an organic or inorganic acid include metal carbonates such as magnesium carbonate, calcium carbonate, sodium carbonate, potassium carbonate, barium sulfate, calcium sulfate, sodium benzoate, and aluminum p-tert-butylbenzoate. The phosphate ester metal salt is exemplified by an aromatic phosphate ester metal salt. The polyol derivative is exemplified by dibenzylidene sorbitol. In consideration of heat resistance, the nucleating agent is preferably an inorganic material.

The substrate layer 11 is flexible and can provide good support to the first surface layer 12 to obtain a desired embossing effect. In consideration of mechanical properties and thermal properties, the material of the substrate layer 11 is polyester that can be obtained by a reaction between the diacid component and the diol component. The diacid component may be an aromatic diacid or an alicyclic diacid. The diol component may be an aromatic diol, an aliphatic diol, or an alicyclic diol.

Specific examples of the aromatic diacid include terephthalic acid, isophthalic acid, phthalic acid, naphthalene dicarboxylic acid, diphenyl sulfone dicarboxylic acid, diphenyl ether dicarboxylic acid, diphenyl ketone dicarboxylic acid, phenylindane dicarboxylic acid, sodium isophthalate sulfonate, and dibromoterephthalic acid. Specific examples of the alicyclic diacid include oxalic acid, succinic acid, adipic acid, azelaic acid, sebacic acid, and dimer acid. The diol(s) may be an aromatic diol, an aliphatic diol, an alicyclic diol, or a combination thereof.

Specific examples of the aromatic diol include naphthalenediol, 2,2-bis(4-hydroxydiphenyl)propane, 2,2-bis(4-hydroxyethoxyphenyl)propane, bis(4-hydroxyphenyl) sulfone, and hydroquinone. Specific examples of the aliphatic diol include ethylene glycol, propylene glycol, 1,4-butanediol, hexanediol, neopentyl glycol, and diethylene glycol. Specific examples of the alicyclic diol include cyclohexanedimethanol and cyclohexanediol.

In certain embodiments, the polyester for forming the substrate layer 11 may be selected from polyethylene terephthalate (PET), polytrimethylene terephthalate (PPT), polybutylene terephthalate (PBT), polyethylene naphthalate (PEN), polybutylene naphthalate (PBN), polycyclohexylenedimethylene terephthalate (PCT), polycarbonate (PC), or polyarylate. The substrate layer 11 is preferably formed from PET.

In order to further increase the heat resistance and processability of the substrate layer 11, the substrate layer 11 can also contain 0.0003 to 2 wt % of the nucleating agent. Specific examples of the nucleating agent are mentioned above, and will not be reiterated herein. Furthermore, the thickness of the substrate layer 11 can be between 5 μm and 300 μm, preferably between 8 μm and 200 μm, and more preferably between 11 μm and 100 μm.

### Second Embodiment

In the present embodiment, the material of the first surface layer 12 is a polyester-based copolymer that includes residues derived from a diacid component and residues derived from a diol component. The diacid component includes 95 mol % of terephthalic acid and 5 mol % of isophthalic acid. The diol component includes 67 mol % of ethylene glycol, 8 mol % of neopentyl glycol, and 25 mol % of 1,4-butanediol. The total thickness of the polyester film is 15 μm, in which the thickness of the first surface layer 12 is 1 μm. The polyester-based copolymer has a glass transition temperature (Tg) of 55° C. and a melting point (Tm) of 225° C. The polyester film 1 has an excellent processability (e.g., calenderability), such that it can be easily embossed.

### Third Embodiment

In the present embodiment, the material of the first surface layer 12 is a polyester-based copolymer that includes residues derived from a diacid component and residues derived from a diol component. The diacid component includes 90 mol % of terephthalic acid and 10 mol % of isophthalic acid. The diol component includes 50 mol % of ethylene glycol, 14 mol % of neopentyl glycol, and 36 mol % of 1,4-butanediol. The total thickness of the polyester film is 50 μm, in which the thickness of the first surface layer 12 is 1.5 μm. The polyester-based copolymer has a glass transition temperature (Tg) of 47° C. The polyester film 1 has an excellent processability (e.g., calenderability), such that it can be easily embossed.

### Fourth Embodiment

In the present embodiment, the material of the first surface layer 12 is a polyester-based copolymer that includes residues derived from a diacid component and residues derived from a diol component. The diacid component includes 88 mol % of terephthalic acid and 12 mol % of isophthalic acid. The diol component includes 55 mol % of ethylene glycol, 5 mol % of neopentyl glycol, and 40 mol % of 1,4-butanediol. Furthermore, the substrate layer 11 and the first surface layer 12 each contain 0.005 wt % of a nucleating agent. The total thickness of the polyester film is 50 μm, in which the thickness of the first surface layer 12 is 2 μm. The polyester-based copolymer has a glass transition temperature (Tg) of 50° C. and a melting point (Tm) of 195° C. The polyester film 1 has an excellent processability (e.g., calenderability), such that it can be easily embossed.

### Fifth Embodiment

Referring to FIG. 3, a fifth embodiment of the present disclosure provides a polyester film 1 for being embossed with a laser-engraved pattern, which is a triple-layered structure including a substrate layer 11, a first surface layer 12, and a second surface layer 13. The substrate layer 11 has a first surface 111 and a second surface 112 opposite to the first surface 111. The first surface 111 is, for example, an upper surface of the substrate layer 11, and the second surface 112 is, for example, a lower surface of the substrate layer 11. The first surface layer 12 is formed on the first surface 111 of the substrate layer 11, and the second surface layer 13 is formed on the second surface 112 of the substrate layer 11. The first surface layer 12 and the second surface layer 13 are each an easy-to-press embossed pattern layer. In practice, the first surface layer 12 and the second surface layer 13 can each be formed with a three-dimensional embossed pattern (not shown). The three-dimensional embossed pattern of the first surface layer 12 can be the same as or different from that of the second surface layer 13.

In the present embodiment, the materials of the first surface layer 12 and the second surface layer 13 are each a polyester-based copolymer that includes residues derived from a diacid component and residues derived from a diol component. The diacid component includes 85 mol % of terephthalic acid and 15 mol % of isophthalic acid. The diol component includes 35 mol % of ethylene glycol, 15 mol % of neopentyl glycol, and 50 mol % of 1,4-butanediol. Furthermore, the substrate layer 11 and the first and second surface layers 12, 13 each contain 0.01 wt % of a nucleating agent. The total thickness of the polyester film is 50 μm, in which the thickness of each of the first and second surface layer 12, 13 is 1% to 30% of the total thickness, preferably 2% to 20%, and more preferably 3% to 15%. The polyester-based copolymer has a glass transition temperature (Tg) of 52° C. and has an excellent processability (e.g., calenderability), such that it can be easily embossed. If the thickness of the first surface layer 12/the second surface layer 13 is greater than 30% of the total thickness, the film forming processability would be negatively affected. If the thickness of the first surface layer 12/the second surface layer 13 is less than 1% of the total thickness, the effect of the resulting embossed pattern may be unsatisfactory. It is worth mentioning that, the first surface layer 12/the second surface layer 13 has an excellent processability (e.g., calenderability), such that it can be easily embossed.

### Sixth Embodiment

Referring to FIG. 4, a sixth embodiment of the present disclosure provides a polyester film 1 for being embossed with a laser-engraved pattern, which includes a substrate layer 11, a first surface layer 12, and a second surface layer 13. The substrate layer 11 is a structure with two or more layers, and has a first surface 111 and a second surface 112 opposite to the first surface 111. The first surface 111 is, for example, an upper surface of the substrate layer 11, and the second surface 112 is, for example, a lower surface of the substrate layer 11. The first surface layer 12 is formed on the first surface 111 of the substrate layer 11, and the second surface layer 13 is formed on the second surface 112 of the substrate layer 11. The first surface layer 12 and the second surface layer 13 are each an easy-to-press embossed pattern layer. In practice, the first surface layer 12 and the second surface layer 13 can each be formed with a three-dimensional embossed pattern (not shown). The three-dimensional embossed pattern of the first surface layer 12 can be the same as or different from that of the second surface layer 13.

More specifically, the substrate layer 11 can include a first substrate layer 11a and a second substrate layer 11b laminated together, as shown in FIG. 4, but it is not limited thereto. The composition of the first substrate layer 11a can be the same as or different from that of the second substrate layer 11b. For example, the first substrate layer 11a and the second substrate layer 11b can be formed from different polyesters, or can contain different functional additives. Other implementation details related to the polyester film 1 for being embossed with a laser-engraved pattern have been mentioned in the first and second embodiments, and will not be reiterated herein.

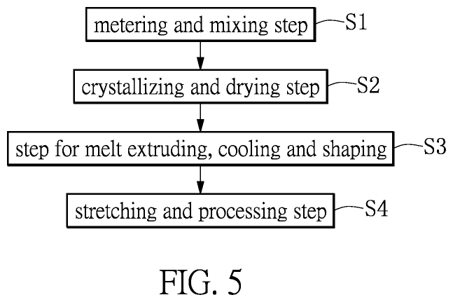

Referring to FIG. 5, which is to be read in conjunction with FIGS. 1, 3, and 4, the present disclosure further provides a manufacturing method of the polyester film 1 for being embossed with a laser-engraved pattern which is mentioned in the above embodiments. The manufacturing method of the present disclosure includes: step S1, i.e., a metering and mixing step, metering and mixing all required ingredients to form at least one polyester composition; step S2, i.e., a crystallizing and drying step, performing a crystallizing and drying process at a temperature from 120° C. to 180° C. on the polyester composition; step S3, i.e., a step for melt extruding, cooling and shaping, melting and extruding the polyester composition and then casting and cooling the resulting extrudate to obtain an unstretched polyester thick film; and step S4, i.e., a stretching and processing step, preheating and stretching the unstretched polyester thick film and heat shrinking the resulting stretched polyester film in the transverse direction and/or the machine direction.

In the step S1, general masterbatches of substrate and surface layers are uniformly mixed with respective functionally modified polyester masterbatches resulted from at least one additive (e.g., a nucleating agent) in a metered manner. Thus, mixed polyester materials of the substrate and surface layers are obtained. In practice, the at least one additive of the functionally modified polyester masterbatches can be added into a polymerization or blending process.

The step S2 is a crystallizing and drying step, in which a crystallizing and drying process at a temperature from 120° C. to 180° C. is performed on a polyester material (i.e., a polyester masterbatch). Thus, the polyester material has a water content less than 30 ppm. The process time of the crystallizing and drying process can range from 3 to 8 hours, but it is not limited thereto.

The step S3 is a step for melt extruding, cooling and shaping, in which the polyester material is melt-extruded and the resulting extrudate is cast, cooled and shaped to form an unstretched polyester thick film More specifically, the polyester material can be formed into a melt with fluidity in a single-layered extrusion or multi-layered co-extrusion manner, which can be achieved by a twin screw extruder. After that, the melt is cast into a film between casting rolls and cooled for solidification. However, these details are provided for exemplary purposes only, and are not meant to limit the scope of the present disclosure.

The step S4 is a stretching and processing step, in which the unstretched polyester thick film is preheated and stretched and the resulting stretched polyester film is heat shrunk in the transverse direction and/or the machine direction. In practice, a sequential or simultaneous biaxial stretching process can be used in the step S4. It is worth mentioning that, under specific stretch conditions, the crystal orientation of the polyester film can be completed, and the polyester film can have a very low thermal shrinkage rate in both the machine direction and the transverse direction under high temperature environment.

More specifically, the unstretched polyester thick film is stretched in the machine direction (MD) (also referred to as “length direction”) at a stretch ratio from 2 to 6 times and a temperature from 70° C. to 145° C. to form a uniaxially stretched polyester film. The uniaxially stretched polyester film is then stretched in the transverse direction (TD) (also referred to as “width direction”) at a stretch ratio from 2 to 6 times and a temperature from 90° C. to 160° C. to form a biaxially stretched polyester film. According to practical requirements, the stretching processes of the machine direction and the transverse direction can be performed in reverse order. A conventional tenter stretching machine can be used to stretch the polyester film, but it is not limited thereto.

Furthermore, the unstretched polyester thick film can be simultaneously and biaxially stretched. More specifically, the unstretched polyester thick film can be simultaneously stretched in the machine direction and the transverse direction at a stretch ratio from 2 to 6 times and a temperature from 70° C. to 160° C., so as to directly form the biaxially stretched polyester film

It is worth mentioning that, the step S4 includes pre-shrinking the biaxially stretched polyester film in the transverse direction and/or the machine direction, which can increase the crystallinity of the polyester film and improve the shrinkage stress of the polyester film. More specifically, in the pre-shrinking process, two ends of the polyester film in the width or length direction can be clamped by clamping fixtures, and thus the polyester film can be stretched and relaxed repeatedly. The extent of each stretching action is 500% and the extent of each relaxing action is 10%. Therefore, the thermal shrinkage of the polyester film at high temperatures can be effectively suppressed. That is, the thermal dimensional stability of the polyester film can be increased without any additional heat treatment after stretching.

### Property Evaluation

Polyester films of Examples 1 to 4 and Comparative Examples 1 and 2 have an A/B structure (i.e., a double-layered structure) as shown in FIG. 1, and a polyester film of Comparative Example 5 has an A/B/A structure (i.e., a triple-layered structure), in which A represents a surface layer and B represents a substrate layer. The compositions of the substrate and surface layers are each shown in Table 1. The polyester films are tested for key physical properties by the following test methods, and the results are shown in Table 1.

Test of Visible Light Transmittance and Haze:

A testing device (model name “TC-HIII DPK”, produced by Tokyo Denshoku Co., Ltd., Japan) was used to test the visible light transmittances and haze levels of the polyester films of Examples 1 to 5 and Comparative Examples 1 and 2 in accordance with JIS K7705 test standards before and after being heated. Also, a variation in haze (Ahaze) of each of the polyester films was calculated. In this test, an oven was used for heating at a temperature of 210° C. for 3 hours.

Test of Embossment Retention Property:

An embossing nickel board was placed at a bottom part of a pressing machine. Each of polyester film samples of Examples 1 to 5 and Comparative Examples 1 and 2 was placed between two steel boards for hot pressing at a temperature of 200° C. and a pressure of 50 kgf for 1 second. After that, the polyester film samples, each of which was separated from the two steel boards, were observed for respective embossed patterns, and the results were recorded in Table 1.

Test of Heat Resistance:

Polyester film samples of Examples 1 to 5 and Comparative Examples 1 and 2 were each cut into a length of 15 cm×15 cm, and were placed into an oven and heated at a temperature of 180° C. for 3 minutes. After that, the heated polyester film samples were removed out of the oven for observation of the integrity of embossed patterns. If a heated polyester film sample has a complete embossed pattern and a flat film surface, it would be judged as having good heat resistance.

TABLE 1

| | | | | | | | | Comparative | |
|---|---|---|---|---|---|---|---|---|---|
| | | | Examples | | | | | Examples | |
| Items | | | 1 | 2 | 3 | 4 | 5 | 1 | 2 |
| Film | Total thickness (μm) | | 12 | 15 | 50 | 50 | 50 | 50 | 50 |
| | Co-extruded structure | | A/B | A/B | A/B | A/B | A/B/A | A/B | A/B |
| | Number of layers | | 2 | 2 | 2 | 2 | 3 | 2 | 2 |
| | Thickness of | | 1/11 | 1/14 | 1.5/48.5 | 2/48 | 1/48/1 | 1.5/48.5 | 1.5/48.5 |
| | each layer (μm) | | | | | | | | |
| Composition | Diol | Ethylene glycol | 49 | 67 | 50 | 55 | 35 | 100 | 50 |
| of A layer | component | (mol %) | | | | | | | |
| | | Neopentyl | 1 | 8 | 14 | 5 | 15 | — | 15 |
| | | glycol (mol %) | | | | | | | |
| | | 1,4-butanediol | 50 | 25 | 36 | 40 | 50 | — | 35 |
| | | (mol %) | | | | | | | |
| | Diacid | Terephthalic | 90 | 95 | 90 | 88 | 85 | 100 | 84 |
| | component | acid (mol %) | | | | | | | |
| | | Isophthalic acid | 10 | 5 | 10 | 12 | 15 | — | 16 |
| | | (mol %) | | | | | | | |
| | Nucleating agent (ppm) | | — | — | — | 50 | 100 | — | |
| Composition | Diol | Ethylene glycol | 100 | 100 | 100 | 100 | 100 | 100 | 100 |
| of B layer | component | (mol %) | | | | | | | |
| | Diacid | Terephthalic | 100 | 100 | 100 | 100 | 100 | 100 | 100 |
| | component | acid (mol %) | | | | | | | |

| | | | | | | | | |
|---|---|---|---|---|---|---|---|---|
| | Nucleating agent (ppm) | — | — | — | 50 | 100 | — | — |
| Film | Haze (%) | 1.3 | 2.14 | 2.45 | 2.14 | 2.51 | 2.12 | 2.16 |
| properties | Light transmittance (TT %) | 90.2 | 90.3 | 89.9 | 90.1 | 89.6 | 89.1 | 89.8 |
| | Tg of A layer (° C.) | 45 | 55 | 47 | 50 | 52 | 78 | 35 |
| | Tc of A layer (° C.) | 171 | 167 | 173 | 170 | 167 | 140 | 180 |
| | Tm of A layer (° C.) | 223 | 225 | — | 195 | — | 253 | — |
| | Embossing retention property | Good | Good | Good | Good | Good | Poor | Good |
| | (220° C.) | | | | | | | |
| | Heat resistance (180° C.) | Good | Good | Good | Good | Good | Good | Poor |

It can be seen that, the polyester films of Examples 1 to 5, in which the material of the surface layer (e.g., easy-to-press embossed pattern layer) is a polyester-based copolymer that contains specific molar ratios of residues of ethylene glycol, neopentyl glycol, 1,4-butanediol, terephthalic acid, and isophthalic acid that can achieve the best comprehensive performance of lowering the melting point, improving the embossing processability and the heat resistance.

In the polyester films of Examples 4 and 5, the substrate and surface layers each contain a nucleating agent, which can improve heat resistance and prevent the formation of large crystals. Therefore, after the polyester film is embossed at a temperature of 200° C., the surface layer has good heat resistance and formability. In the presence of the nucleating agent contained in the substrate layer, the polyester film has good heat resistance and good dimensional stability, and the thermal shrinkage and warpage thereof which is resulted from the difference between the compositions of the substrate and surface layers can be avoided.

The polyester film of Comparative Example 1, in which the material of the substrate layer is polyethylene terephthalate, and the embossing of resulting products are clearly poor.

Although the polyester film of Comparative Example 2 has good embossing retention properties, an embossed pattern of the surface layer becomes unapparent after being heated at a temperature of 180° C. for 3 minutes. Furthermore, the polyester film may have shrinkage or warpage deformation, which cannot meet the requirements of a product embossed with a laser-engraved pattern.

One of the effects of the present disclosure is that the polyester film can be embossed with a clear laser-engraved pattern on a surface thereof which has different shades of color, by virtue of “the at least one surface layer is formed on the substrate layer and a material thereof is a polyester-based copolymer that includes residues derived from a diacid component and residues derived from a diol component” and “the diacid component includes 85 to 95 mol % of terephthalic acid and 5 to 15 mol % of isophthalic acid, and the diol component includes 35 to 74 mol % of ethylene glycol, 1 to 15 mol % of neopentyl glycol, and 25 to 50 mol % of 1,4-butanediol.”

In addition, the manufacturing method of the polyester film, which uses a multi-layered co-extrusion manner to form two, three, or more functional polyester layers that are laminated together, can efficiently reduce the processing difficulty and improve the yield of finished products.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyester film for being embossed with a laser-engraved pattern, comprising:
a substrate layer; and
at least one surface layer formed on the substrate layer, wherein a material of the at least one surface layer is a polyester-based copolymer that includes residues derived from a diacid component and residues derived from a diol component, the diacid component includes 85 to 95 mol % of terephthalic acid and 5 to 15 mol % of isophthalic acid, and the diol component includes 35 to 74 mol % of ethylene glycol, 1 to 15 mol % of neopentyl glycol, and 25 to 50 mol % of 1,4-butanediol.

2. The polyester film according to claim 1, wherein a material of the substrate layer is polyethylene terephthalate.

3. The polyester film according to claim 2, wherein the at least one surface layer contains 0.0003 to 2 wt % of a nucleating agent.

4. The polyester film according to claim 3, wherein the substrate layer contains 0.0003 to 2 wt % of a nucleating agent.

5. The polyester film according to claim 4, wherein a thickness of the at least one surface layer is 1% to 30% of a total thickness of the polyester film, and a thickness of the substrate is between 11 μm and 100 μm.

6. The polyester film according to claim 5, wherein the thickness of the at least one surface layer is 2% to 20% of the total thickness of the polyester film.

7. The polyester film according to claim 6, wherein the thickness of the at least one surface layer is 3% to 15% of the total thickness of the polyester film.

8. The polyester film according to claim 4, wherein a melting point of the polyester-based copolymer is 190° C. to 240° C.

9. The polyester film according to claim 8, wherein the melting point of the polyester-based copolymer is 195° C. to 230° C.

10. A manufacturing method of a polyester film for being embossed with a laser-engraved pattern, comprising:
forming a substrate layer and at least one surface layer on the substrate layer in a multi-layered co-extrusion manner, wherein a material of the at least one surface layer is a polyester-based copolymer that includes residues derived from a diacid component and residues derived from a diol component, the diacid component includes 85 to 95 mol % of terephthalic acid and 1 to 15 mol % of isophthalic acid, and the diol component includes 35 to 74 mol % of ethylene glycol, 1 to 15 mol % of neopentyl glycol, and 25 to 50 mol % of 1,4-butanediol; and stretching the substrate layer and the at least one surface layer in a machine direction (MD) and a transverse direction (TD).

11. The manufacturing method according to claim 10, wherein a material of the substrate layer is polyethylene terephthalate.

12. The manufacturing method according to claim 11, wherein the at least one surface layer contains 0.0003 to 2 wt % of a nucleating agent.

13. The manufacturing method according to claim 12, wherein the substrate layer contains 0.0003 to 2 wt % of a nucleating agent.

14. The manufacturing method according to claim 13, wherein a thickness of the at least one surface layer is 1% to 30% of a total thickness of the polyester film, and a thickness of the substrate is between 11 μm and 100 μm.

15. The manufacturing method according to claim 14, wherein the thickness of the at least one surface layer is 2% to 20% of the total thickness of the polyester film.

16. The manufacturing method according to claim 15, wherein the thickness of the at least one surface layer is 3% to 15% of the total thickness of the polyester film.

17. The manufacturing method according to claim 12, wherein a melting point of the polyester-based copolymer is 190° C. to 240° C.

18. The manufacturing method according to claim 17, wherein the melting point of the polyester-based copolymer is 195° C. to 230° C.
